(19) United States
(12) Patent Application Publication
(10) Pub. No.: US 2026/0350718 A1
(43) Pub. Date: Nov. 5, 2026

(54) SUPPLY AND DEMAND ADJUSTMENT APPARATUS, SUPPLY AND DEMAND ADJUSTMENT METHOD, AND PROGRAM

(71) Applicant: NIPPON TELEGRAPH AND TELEPHONE CORPORATION, Tokyo (JP)

(72) Inventors: Ryota NAKAMURA, Tokyo (JP); Shigeaki HARADA, Tokyo (JP)

(73) Assignee: NIPPON TELEGRAPH AND TELEPHONE CORPORATION, Tokyo (JP)

(21) Appl. No.: 19/105,012

(22) PCT Filed: Aug. 22, 2022
(86) PCT No.: PCT/JP2022/031585

§ 371 Date: Feb. 19, 2025

(51) Int. Cl. G06Q 50/06

(52) U.S. Cl. CPC G06Q 50/06

(57) ABSTRACT

A supply and demand adjustment device for adjusting supply and demand of power between a plurality of microgrids, the device including an information collection unit that collects information from each of the microgrids, a control unit that determines a one-to-one pair of a microgrid as a power interchange source and a microgrid as a power interchange destination in accordance with a priority order determined on a basis of the information collected by the information collection unit, and a control command unit that instructs the pair to perform power interchange.

### TECHNICAL FIELD

The present invention relates to a technology for adjusting supply and demand by cooperation of a plurality of microgrids.

### BACKGROUND ART

In recent years, renewable energy has attracted attention from the global trend toward decarbonization, and it is assumed that the introduction amount of renewable energy power sources will increase in the future. Solar power generation and wind power generation, which are representative among renewable energy, are clean power without requiring fossil fuel at the time of power generation, but stable output is difficult to obtain because power generation output is greatly affected by weather changes such as solar radiation amount and wind speed. Accordingly, when more renewable energy is introduced into the power system in the future, there is a possibility that a deviation of a frequency proper range due to output fluctuation or the like occurs.

As a countermeasure against the output fluctuation of the renewable energy, there is storage battery control. For example, Non Patent Literature 1 discloses an output control method in which performance such as a life of a storage battery is also considered in response to a rapid output fluctuation of solar power generation. However, in order to absorb the output fluctuation of a large amount of introduced renewable energy only by this method, an enormous amount of storage battery equipment is required.

Further, Non Patent Literature 2 discloses a method of spatially controlling a power consumption amount by controlling an ICT load between bases across the country using a virtualized network. However, there is a limit to the amount of power that can be adjusted only by the ICT load, and thus it is unclear whether the supply and demand balance can be maintained only by this method in an age in which a large amount of renewable energy is introduced.

Furthermore, in the technology disclosed in Non Patent Literature 3, not only a storage battery but also demand control is cooperated with respect to the fluctuation of renewable energy in a microgrid to adjust the supply and demand. However, this method is limited to supply and demand adjustment control in one microgrid.

### CITATION LIST

### Non Patent Literature

Non Patent Literature 1: Seiya Miyazaki and four others, “Power Balancing Control for Energy Management Systems”, Panasonic Technical Journal Vol 57 No 4 Jan. 2012 Non Patent Literature 2: Ryota Nakamura and Shigeaki Harada, “Saisei kanou energy wo kouryo shita ICT fukahaiti shuho no teian (in Japanese) (Proposal of ICT load placement method considering renewable energy)”, IEICE General Conference, B-14-4, March 2022 Non Patent Literature 3: Yasuhiro Kojima, Masanobu Koshio, Shizuka Nakamura, “Development and Evaluation of Control System for Microgrid Supplying Heat and Electricity”, 2008, The Institute of Electrical Engineers of Japan

### SUMMARY OF INVENTION

### Technical Problem

In the prior art, a technology for adjusting supply and demand in a microgrid has been proposed from the viewpoint of local production and local consumption of energy. However, when the introduction amount of renewable energy is improved, power waste is likely to occur only by control in the microgrid, and thus it is required to efficiently utilize renewable energy by interchanging power between microgrids as well as by the conventional local production and local consumption of energy.

However, when an operation pattern for power interchange is derived from a combination of control contents of all energy resources between microgrids and within a microgrid, the calculation time becomes enormous. Therefore, in the prior art, it is difficult for a plurality of microgrids to cooperate to adjust the supply and demand of power.

The present invention has been made in view of the above points, and an object of the present invention is to provide a technology for adjusting supply and demand of power by cooperation of a plurality of microgrids.

### Solution to Problem

According to the disclosed technology, there is provided a supply and demand adjustment device for adjusting supply and demand of power between a plurality of microgrids, the supply and demand adjustment device including:
an information collection unit that collects information from each of the microgrids;
a control unit that determines a one-to-one pair of a microgrid as a power interchange source and a microgrid as a power interchange destination in accordance with a priority order determined on the basis of the information collected by the information collection unit; and
a control command unit that instructs the pair to perform power interchange.

### Advantageous Effects of Invention

According to the disclosed technology, there is provided a technology for adjusting supply and demand of power in cooperation of a plurality of microgrids.

### BRIEF DESCRIPTION OF DRAWINGS

FIG. 1 is a diagram illustrating an overall configuration example of a system.

FIG. 2 is a diagram illustrating a configuration example of a supply and demand adjustment device 100.

FIG. 3 is a flowchart for describing operation of the supply and demand adjustment device 100.

FIG. 4 is a diagram illustrating a hardware configuration example of the device.

### DESCRIPTION OF EMBODIMENTS

Hereinafter, an embodiment of the present invention (the present embodiment) will be described with reference to the drawings. The embodiment to be described below is merely exemplary, and embodiments to which the present invention is applied are not limited to the following embodiment.

### Problems

First, problems to be solved in the technology according to the present embodiment will be described in detail.

As described above, in the prior art, a technique of adjusting supply and demand in a microgrid has been proposed from the viewpoint of local production and local consumption of energy. However, in a situation where a large amount of renewable energy is introduced and the power output fluctuates due to a weather change, if control is only performed in the microgrid, demand control such as power saving is performed due to power shortage in a certain microgrid depending on a supply and demand situation, and on the other hand, there is a possibility that power is wasted due to output suppression of a power generation facility due to power surplus in the other microgrid.

When the introduction amount of renewable energy is improved in this manner, power waste is likely to occur only by control in the microgrid, and thus it is required to efficiently utilize renewable energy by interchanging power between microgrids as well as by the conventional local production and local consumption of energy. In such a situation, supply and demand control across areas has been studied in some cases, or a system related to transmission of renewable energy to a remote base such as self-consignment has been designed, whereby power supply and demand control between microgrids has become possible.

In the world where a large amount of renewable energy will be introduced in the future, it is required to maintain the supply and demand balance while further improving utilization efficiency of renewable energy by combining energy resource control between these microgrids and within a microgrid, and to aim at increasing the green power introduction amount and stabilizing the power quality.

However, there is a plurality of types of energy resources to be interchanged in each microgrid. When the energy resources are adjusted between the microgrids, the energy resources are interchanged from a surplus area to a tight area, but there are many combinations of which energy resources of which surplus microgrid are interchanged with which tight microgrid.

Specifically, when the number of tight microgrids is denoted by g and the number of energy resources of surplus microgrids is denoted by r, the total interchange pattern of the energy resources is O(g^{r}), which is an exponential time. Further, since there are energy resources for supply and demand adjustment within the microgrid, the calculation time becomes enormous when an operation pattern is derived from a combination of control contents of all energy resources to which these controls are added.

Therefore, in a situation where power is excessive or insufficient in each microgrid, the problem of which energy resource is used to interchange power from which microgrid with which microgrid and how to combine resource controls in the microgrid cannot be solved by a combination of existing technologies that maintain a supply and demand balance of a single microgrid, and there is a problem that it is difficult to solve the problem within a realistic time as the number of energy resources increases.

### Outline of Embodiment

In the present embodiment, a supply and demand adjustment device 100 to be described later solves the above problems and performs power supply and demand adjustment in cooperation between microgrids.

The supply and demand adjustment device 100 classifies each microgrid into a surplus group and a tight group, determines priority in each group and selects one microgrid, and determines a pair of a power interchange source and an interchange destination of 1:1. Then, regarding the selection of the energy resources to be interchanged from the interchange source, a cost function is defined and interchange is performed in a resource selection order until the tightness or surplus is resolved. By repeating the 1:1 power interchange as described above, the control between the microgrids of each energy resource is determined within a feasible time.

Further, after the interchange, when a further supply and demand balance is required, the control is performed by control in the microgrid, so that the power supply and demand adjustment is achieved by energy resource control in consideration of maintaining the supply and demand balance of each microgrid while avoiding a situation in which power is tight in a certain microgrid and power is surplus in another microgrid.

Hereinafter, a configuration and operation according to the present embodiment will be described in more detail.

### Overall Configuration Example

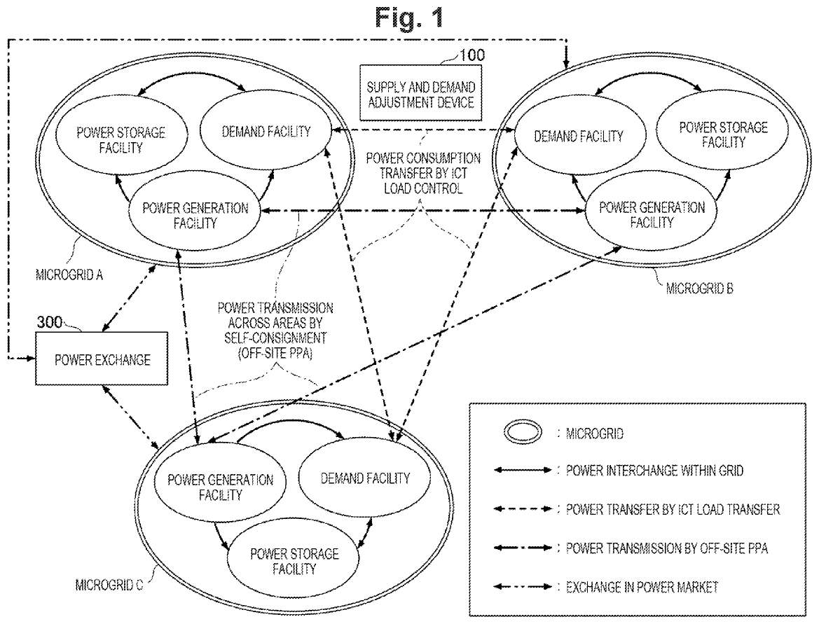

FIG. 1 illustrates an overall configuration example of a system according to the present embodiment. In the example of FIG. 1, microgrids A to C are present, Each microgrid has one or more power storage facilities, one or more demand facilities, one or more power generation facilities. There may be a microgrid in which any one or any two of the power storage facility, the demand facility, and the power generation facility are not present.

The power storage facility is a storage battery, an electric vehicle, or the like. The demand facility is a general home, a factory, a company, or the like. The power generation facility here is assumed to be a power generation facility using renewable energy. However, the power generation facility may be a power generation facility that does not use renewable energy.

Further, as illustrated in FIG. 1, the present system includes the supply and demand adjustment device 100 and a power exchange 300. The supply and demand adjustment device 100 is connected to each microgrid via a network, and performs supply and demand adjustment control described below by communicating with each microgrid.

In each microgrid, in addition to power generation by renewable energy of a power generation facility and power consumption by a demand facility, supply and demand balance adjustment (power interchange in the grid) is performed by charging and discharging of a power storage facility and demand reduction by power saving of a demand facility. In addition, between microgrids, a base where power consumption occurs is physically transferred by ICT load transfer using a virtual network.

Furthermore, in recent years, the off-site Power Purchase Agreement (PPA) system makes it possible to transmit renewable energy to a base at a long distance and to select a supply destination base. In this way, by controlling a plurality of microgrids in cooperation by combining energy resources (supply destination base of renewable energy, operation base of ICT load) that can be transferred and controlled between microgrids and energy resources (control of demand facilities and power storage facilities) controlled in the microgrids, it is possible to effectively utilize renewable energy and to further stabilize and improve the supply and demand balance even in the age in which a large amount of renewable energy is introduced.

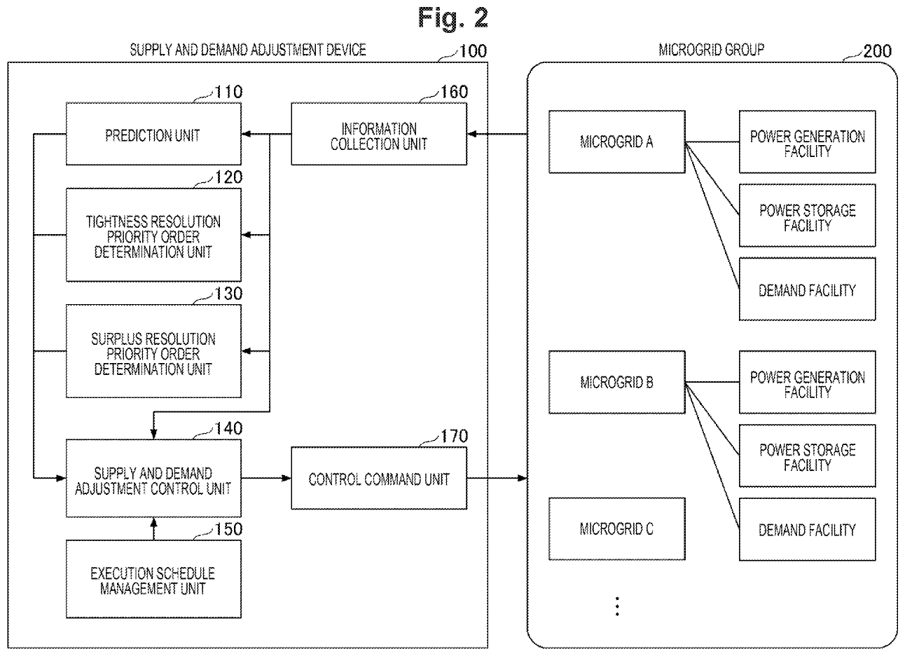

(Configuration of supply and demand adjustment device 100) FIG. 2 illustrates a configuration example of the supply and demand adjustment device 100 according to the present embodiment. The supply and demand adjustment device 100 can communicate with the microgrid group 200 via a network.

As illustrated in FIG. 2, the supply and demand adjustment device 100 includes an information collection unit 160, a prediction unit 110, a tightness resolution priority order determination unit 120, a surplus resolution priority order determination unit 130, a supply and demand adjustment control unit 140, a control command unit 170, and an execution schedule management unit 150. Note that the “prediction unit 110, tightness resolution priority order determination unit 120, surplus resolution priority order determination unit 130, and supply and demand adjustment control unit 140” may be collectively referred to as a “control unit”.

The information collection unit 160 collects, from each microgrid, power generation information of the power generation facility, demand information of the demand facility, power storage residual amount information of the power storage facility, and the like.

The prediction unit 110 predicts a power generation amount and a demand amount on the basis of the information collected by the information collection unit 160.

The tightness resolution priority order determination unit 120 determines a tightness resolution priority order of each microgrid on the basis of the information collected by the information collection unit 160.

The surplus resolution priority order determination unit 130 determines a surplus resolution priority order of each microgrid on the basis of the information collected by the information collection unit.

The supply and demand adjustment control unit 140 determines the operation of the power generation facility, the demand facility, and the power storage facility on the basis of each piece of information obtained from the information collection unit 160, the prediction unit 110, the tightness resolution priority order determination unit 120, and the surplus resolution priority order determination unit 130 so that the renewable energy can be used most efficiently, and transmits the result to the control command unit 170.

The control command unit 170 transmits a control instruction content of each energy resource existing under the control of each microgrid. That is, the control command unit 170 instructs the target microgrid to execute power interchange or the like. Each microgrid receiving the control instruction content executes control of each energy resource on the basis of the control instruction content.

The execution schedule management unit 150 instructs these control execution timings. For adjustment of the supply and demand balance, the same time and same amount as planned values at every 30 minutes are required, and thus it is considered as an example to execute the control every 30 minutes. In addition, while the supply and demand balance of each microgrid is monitored, the control may be executed at any time when the supply and demand mismatch is detected or predicted.

### Operation of Supply and Demand Adjustment Device 100

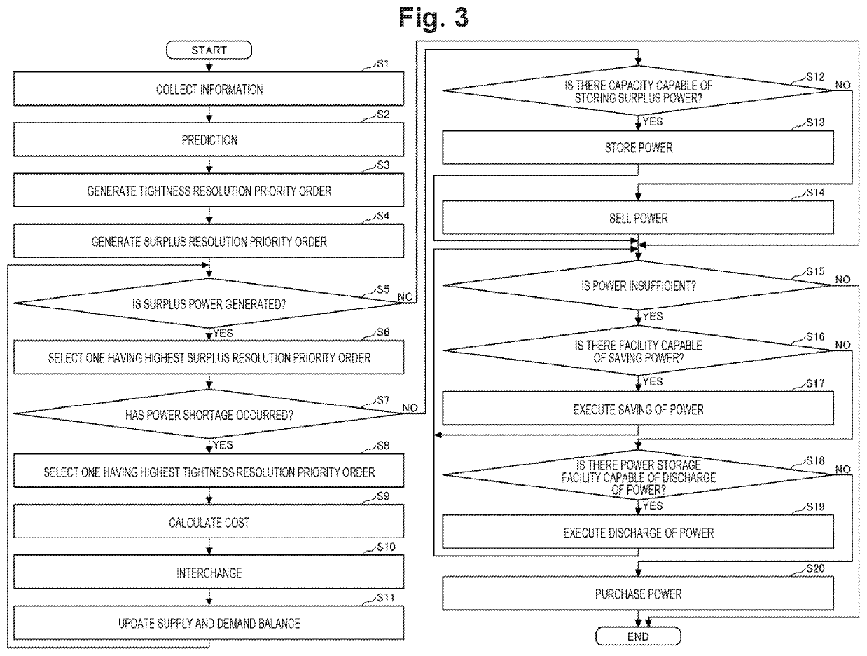

The operation of the supply and demand adjustment device 100 having the above configuration will be described in detail along the procedure of a flowchart of FIG. 3.

### S1: Information Collection

In S1, the information collection unit 160 collects, for example, the following information for each component of each microgrid.
Renewable energy power generation facility: equipment capacity (kW), current power generation amount (kW)
Demand facility: past demand power consumption data and current demand power consumption amount (kWh)
Power storage facility: power storage capacity (kw) and current remaining capacity (kwh)
Weather forecast: temperature, solar radiation, and wind speed
Contractual content with power company: power-selling price and power-purchasing price

### S2: Prediction of Power Consumption Amount and Prediction of Power Generation Amount

In S2, the prediction unit 110 predicts a power generation amount and a power consumption amount for each microgrid, Details are as follows.

The prediction unit 110 predicts future power consumption amount for each microgrid on the basis of a current value, past data, and a weather forecast, For the prediction of the power consumption amount, any method may be used. For example, a prediction value of the power consumption amount can be derived as a primary approximation of the temperature and the power consumption from the past data.

Similarly, the prediction unit 110 predicts a future power generation amount for each microgrid on the basis of a current value, past data, and a weather forecast.

Although any method may be used for the power generation amount prediction, for example, from the past data, a prediction value of the power generation amount can be derived as a primary approximation with the solar radiation amount in the case of solar power generation, and as a primary approximation with the wind speed in the case of wind power generation.

### S3: Creation of Tightness Resolution Priority Order

In S3, the tightness resolution priority order determination unit 120 generates the tightness resolution priority order for each microgrid. Details are as follows.

Depending on climatic conditions and demand conditions, the power of the entire microgrid group may not be covered only by renewable energy. At that time, the supply and demand balance is maintained by power purchase from a power company, but it is assumed that the price of power purchase from the power company varies in each microgrid during the progress of power liberalization.

At that time, cost reduction can be achieved by selecting a microgrid with a low power purchase price as a microgrid that finally maintains balance by power purchase. Here, an order of power purchase prices of power companies in the microgrid is used as an order of preferentially solving the power tightness. That is, the tightness resolution priority order determination unit 120 determines to preferentially resolve the power tightness in descending order of the power purchase prices of power companies in the microgrid.

However, using the order of the power purchase prices is merely an example. The method for determining the tightness resolution priority order is not limited to this, and the priority order may be determined on the basis of, for example, the remaining capacity of the storage battery in each microgrid, or the like.

### S4: Creation of Surplus Resolution Priority Order

In S4, the surplus resolution priority order determination unit 130 generates the surplus resolution priority order for each microgrid. Details are as follows.

Depending on climatic conditions and demand conditions, there is a possibility that all the generated renewable energy cannot be consumed by the entire microgrid group. When there is no capacity to charge the storage battery, power is sold by reverse flow to the system, but at that time, the purchase price unit price (yen/kwh) varies depending on each power company. In consideration of profitability, it is desirable that the microgrid that finally generates a surplus is an area with a high purchase price unit price.

Accordingly, the surplus resolution priority order determination unit 130 determines the order of preferentially resolving the surplus as an order in which the purchase price unit price of the power company in each microgrid is low. However, the method of determining the surplus resolution order is not limited thereto, and the order may be determined on the basis of, for example, the storage battery facility capacity or the like.

### S5 to S11: Interchange of Surplus Power With Other Microgrids

In each microgrid, if there is still a renewable energy generation amount or a remaining capacity of the power storage facility even after the power demand in the microgrid is covered, it is considered that there is surplus power for the microgrid.

The surplus power of a certain microgrid is transmitted to and interchanged with another microgrid when there is power shortage in the grid. At this time, the supply and demand adjustment device 100 selects a microgrid having a high surplus resolution priority order as an interchange source, selects a microgrid having a high tightness resolution priority order as an interchange destination, and performs power interchange until the surplus is resolved or the tightness is resolved.

Regarding interchange to other microgrids, there is a plurality of energy resources such as “power transmission by off-site PPA of renewable energy generation power”, “self-consignment of storage battery discharge power”, and “transfer of ICT load by virtual network”, but it is assumed that respective costs are required the resources, and these costs are compared and interchange is performed in ascending order of cost. The “power transmission by off-site PPA of renewable energy generation power”, the “self-consignment of storage battery discharge power”, the “transfer of ICT load by virtual network”, and the like may be referred to as a power interchange method.

For example, the power transmission by off-site PPA of renewable energy generation power generates a cost (consignment charge) for using the power supply network of the power company, and the self-consignment of storage battery discharge power similarly generates a consignment charge and a renewable energy charge. In addition, additional power consumption for executing the transfer of ICT load is generated, and thus an electricity charge corresponding to the generated power consumption is generated as a cost. All of these costs are proportional to the amount of power to be interchanged (kWh) , and thus can be described by a primary expression of the amount of power to be interchanged in the form of “consignment unit price (yen/kWh)×amount of power (kWh)” or “electricity unit price (yen/kWh)W×amount of power (kWh)”, and the calculation time is sufficiently smaller than the calculation time order that has been a problem in the related art.

Details of the above processing will be described with reference to the flowchart of FIG. 3.

In S5, the supply and demand adjustment control unit 140 determines whether or not there is a microgrid in which surplus power is generated. When there is a microgrid in which surplus power is generated, the process proceeds to S6, and when there is no microgrid in which surplus power is generated, the process proceeds to S15.

In S6, the supply and demand adjustment control unit 140 selects one microgrid having the highest surplus resolution priority order from among one or more microgrids in which surplus power is generated.

In S7, the supply and demand adjustment control unit 140 determines whether or not there is another microgrid in which power shortage has occurred in the same time slot as the time slot in which the surplus power is generated. When there is another microgrid in which power shortage has occurred, the process proceeds to S8, and when there is no other microgrid in which power shortage has occurred, the process proceeds to S12.

In S8, the supply and demand adjustment control unit 140 selects a microgrid having a highest tightness resolution priority order from among one or more microgrids in which power shortage has occurred.

In S9, the supply and demand adjustment control unit 140 calculates a renewable power transmission cost, a storage battery power transmission cost, and an ICT load transfer cost between the selected surplus grid and the deficient grid. That is, the cost for each power interchange in the plurality of power interchange methods is calculated.

In S10, the supply and demand adjustment control unit 140 determines to interchange power of the surplus grid with the deficient grid in ascending order of cost until the power shortage is resolved or the surplus power disappears using the power interchange method, and notifies the control command unit 170 of the control content. The control command unit 170 instructs the pair of the microgrid as the power interchange source and the microgrid as the power interchange destination to execute the power interchange on a one-to-one basis in accordance with the control content.

In S11, the supply and demand adjustment control unit 140 updates the power supply and demand balance of each microgrid, and the process returns to S5.

### S12 to S14: Processing of Surplus Power

When surplus power is generated as a whole group as a result of the interchange between the microgrids, the surplus power is stored in the power storage facility. When the power storage facility does not have sufficient capacity, power selling by reverse flow is performed. Details are as follows.

In S12, the supply and demand adjustment control unit 140 determines whether or not the power storage facility has a capacity capable of storing surplus power, and when the determination result is Yes (present), the process proceeds to S13, and when the determination result is No (absent), the process proceeds to S14.

In S13, the supply and demand adjustment control unit 140 performs control to store the surplus power in the power storage facility via the control command unit 170.

In S14, the supply and demand adjustment control unit 140 performs control to sell the surplus power to the system by reverse flow via the control command unit 170.

### S15 to S19: Demand Adjustment for Power Shortage

When power shortage occurs even after the surplus power interchange, power saving control is performed in the demand facility in the microgrid to reduce the demand power and adjust the supply and demand balance. Further, when there is a power shortage, the power is covered by discharge by the power storage facility. Details are as follows.

In S15, the supply and demand adjustment control unit 140 determines whether or not there is a microgrid with insufficient power. If the determination result is Yes, the process proceeds to S16, and if the determination result is No, the process ends. S16 to S19 are performed for each microgrid having insufficient power.

In S16, the supply and demand adjustment control unit 140 determines whether or not there is a facility capable of saving power in the microgrid. If the determination result is Yes, the process proceeds to S17, and if No, the process proceeds to S18. In S17, the supply and demand adjustment control unit 140 determines to execute power saving in the microgrid, and the control command unit 170 instructs the target microgrid to execute power saving.

In S18, the supply and demand adjustment control unit 140 determines whether or not there is a dischargeable power storage facility in the microgrid. If the determination result is Yes, the process proceeds to S19, and if No, the process proceeds to S20. In S19, the supply and demand adjustment control unit 140 determines to execute discharge from the power storage facility in the microgrid, and the control command unit 170 instructs the target microgrid to execute discharge.

### S20: Power Purchase From System

When power shortage occurs as a result of adjusting the total energy resources as described above, the supply and demand adjustment control unit 140 maintains the supply and demand balance by controlling the difference to be purchased from the system via the control command unit 170.

### Hardware Configuration Example

The supply and demand adjustment device 100 can be implemented by, for example, causing a computer to execute a program. This computer may be a physical computer, or may be a virtual machine on a cloud.

Specifically, the supply and demand adjustment device 100 can be implemented by executing a program corresponding to processing to be performed in the supply and demand adjustment device 100 using hardware resources such as a central processing unit (CPU) and a memory installed in the computer. The above-described program can be stored and distributed by being recorded on a computer-readable recording medium (portable memory, and the like). Furthermore, the program can also be provided via a network such as the Internet or an electronic mail.

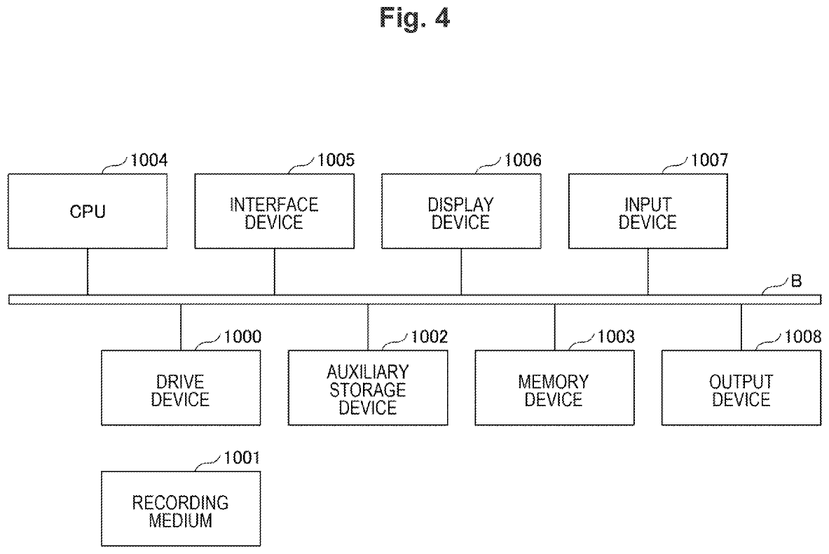

FIG. 4 is a diagram illustrating a hardware configuration example of the computer. The computer in FIG. 4 includes a drive device 1000, an auxiliary storage device 1002, a memory device 1003, a CPU 1004, an interface device 1005, a display device 1006, an input device 1007, an output device 1008, and the like, which are connected to each other by a bus BS.

A program for implementing processing in the computer is provided by, for example, a recording medium 1001 such as a CD-ROM of a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

When an instruction to start the program is given, the memory device 1003 reads the program from the auxiliary storage device 1002 and stores the program. Further, information collected by the information collection unit 160 is stored in the memory device 1003 (or the auxiliary storage device 1002), and the information is read and calculation for control is performed.

The CPU 1004 implements a function related to the supply and demand adjustment device 100 in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, buttons, a touch panel, or the like, and is used to input various operation instructions. The output device 1008 outputs calculation results.

### Effects of Embodiment

The technology according to the present embodiment can achieve effective use of renewable energy and maintenance of a supply and demand balance even when a large amount of renewable energy is introduced by performing power interchange between microgrids by controlling each energy resource in addition to supply and demand control in the microgrids. In addition, as described below, the problem of the prior art that enormous calculation time is required is solved.

The number of surplus microgrids is denoted by f, the number of tight microgrids is denoted by g, the number of energy resources of the surplus microgrids is denoted by r, and the maximum number of energy resources in one microgrid is denoted by rₘ (rₘ≤r).

In the technology according to the present embodiment, considering the power interchange source, the calculation amount for rearrangement in order of determining the surplus resolution priority order and the cost of the energy resources in the surplus microgrid is O (f log f×rₘ log rₘ). In addition, considering the power interchange destination, the calculation amount for determination of the tightness resolution priority order is O(g log g). Therefore, the calculation amount in this method is max [O(f log f×rₘ log rₘ), O(g log g)]. This calculation amount is sufficiently smaller than the calculation amount O(g^{r}) which has been an initial problem, and it is expected that the calculation time can be greatly reduced by the effect of the technology according to the present embodiment.

### Summary of Embodiment

The present specification discloses at least a supply and demand adjustment device, a supply and demand adjustment method, and a program described in each of the following items.

### Supplementary Note 1

A supply and demand adjustment device for adjusting supply and demand of power between a plurality of microgrids, the supply and demand adjustment device including:
a memory; and
at least one processor connected to the memory, in which
the processor
collects information from each of the microgrids,
determines a one-to-one pair of a microgrid as a power interchange source and a microgrid as a power interchange destination in accordance with a priority order determined on the basis of the collected information, and
instructs the pair to perform power interchange.

### Supplementary Note 2

The supply and demand adjustment device according to supplementary note 1, in which
the processor selects, as the microgrid as the power interchange source, a microgrid having a highest surplus resolution priority order from among one or more microgrids in which surplus power is generated, and selects, as the microgrid as the power interchange destination, a microgrid having a highest tightness resolution priority order from among one or more microgrids in which power shortage has occurred.

### Supplementary Note 3

The supply and demand adjustment device according to supplementary note 1 or 2, in which
the processor calculates a cost for power interchange by each of a plurality of power interchange methods for power interchange from the microgrid as the power interchange source with the microgrid serving as the power interchange destination, and determines to perform power interchange by applying the power interchange methods in ascending order of the costs for power interchange.

### Supplementary Note 4

The supply and demand adjustment device according to any one of supplementary notes 1 to 3, in which
when it is determined that supply and demand adjustment is necessary after power interchange between a plurality of microgrids, the processor determines to perform supply and demand adjustment by power control in the microgrids.

### Supplementary Note 5

A supply and demand adjustment method executed by a supply and demand adjustment device for adjusting supply and demand of power between a plurality of microgrids, the method including:
a step of collecting information from each of the microgrids;
a step of determining a one-to-one pair of a microgrid as a power interchange source and a microgrid as a power interchange destination in accordance with a priority order determined on the basis of the collected information; and
a step of instructing the pair to perform power interchange.

### Supplementary Note 6

A non-transitory storage medium that stores a program for causing a computer to function as each unit in the supply and demand adjustment device according to any one of supplementary notes 1 to 4.

Although the present embodiment has been described above, the present invention is not limited to such a specific embodiment, and various modifications and changes can be made within the scope of the concept of the present invention disclosed in the claims.

### REFERENCE SIGNS LIST

100 Supply and demand adjustment device
110 Prediction unit
120 Tightness resolution priority order determination unit
130 Surplus resolution priority order determination unit
140 Supply and demand adjustment control unit
150 Execution schedule management unit
160 Information collection unit
170 Control command unit
200 Microgrid group
300 Power exchange
1000 Drive device
1001 Recording medium
1002 Auxiliary storage device
1003 Memory device
1004 CPU
1005 Interface device
1006 Display device
1007 Input device
1008 Output device

1. A supply and demand adjustment device for adjusting supply and demand of power between a plurality of microgrids, the supply and demand adjustment device comprising a processor configured to execute operations comprising:
collecting information from each of the plurality of microgrids;
determining a pair comprising a source microgrid as a power interchange source and a destination microgrid as a power interchange destination in accordance with a priority order determined on a basis of the collected information; and
instructing the pair to perform power interchange.

2. The supply and demand adjustment device according to claim 1, wherein
the determining further comprises:
selecting, as the source microgrid as the power interchange source, having a highest surplus resolution priority order from among one or more microgrids of the plurality of microgrids in which surplus power is generated, and
selecting, as the destination microgrid as the power interchange destination having a highest tightness resolution priority order from among one or more microgrids of the plurality of microgrids in which power shortage has occurred.

3. The supply and demand adjustment device according to claim 1, wherein
the determining further comprises:
calculating a cost for power interchange by each of a plurality of types of power interchange from the source microgrid with the destination microgrid, and
determining to perform respective types of power interchange of the plurality of types of power interexchange in ascending order of respective costs for power interchange.

4. The supply and demand adjustment device according to claim 1, wherein
when it is determined that supply and demand adjustment is necessary after power interchange between the plurality of microgrids, the determining further comprises determining to perform the supply and demand adjustment by power control in the plurality of microgrids.

5. A supply and demand adjustment method executed by a supply and demand adjustment device for adjusting supply and demand of power between a plurality of microgrids, comprising:
a step of collecting information from each microgrid of the plurality of microgrids;
a step of determining a pair comprising a source microgrid as a power interchange source and a destination microgrid as a power interchange destination in accordance with a priority order determined on a basis of the collected information; and
a step of instructing the pair to perform power interchange.

6. A computer-readable non-transitory recording medium storing a computer-executable program instructions that when executed by a processor cause a computer to execute operations comprising:
collecting information from each microgrid of a plurality of microgrids;
determining a pair comprising a source microgrid as a power interchange source and a destination microgrid as a power interchange destination in accordance with a priority order determined on a basis of the collected information; and
instructing the pair to perform power interchange.

7. The supply and demand adjustment device according to claim 1, wherein the source microgrid comprises a power storage facility.

8. The supply and demand adjustment device according to claim 1, wherein the source microgrid comprises a power generation facility.

9. The supply and demand adjustment device according to claim 1, wherein the destination microgrid comprises a demand facility.

10. The supply and demand adjustment device according to claim 1, wherein the destination microgrid comprises a power storage facility.

11. The supply and demand adjustment device according to claim 1, wherein the information comprises power generation information of said each microgrid, demand information of said each microgrid, and power storage residual amount information of said each microgrid.

12. The supply and demand adjustment device according to claim 1, wherein
the priority order is based on a predicted power generation amount in the source microgrid using a renewable energy, and
the priority order is further based on a predicted power consumption amount in the destination microgrid.

13. The supply and demand adjustment method according to claim 5, wherein
the determining further comprises:
selecting, as the source microgrid as the power interchange source having a highest surplus resolution priority order from among one or more microgrids of the plurality of microgrids in which surplus power is generated, and
selecting, as the destination microgrid as the power interchange destination having a highest tightness resolution priority order from among one or more microgrids of the plurality of microgrids in which power shortage has occurred.

14. The supply and demand adjustment method according to claim 5, wherein
the determining further comprises:
calculating a cost for power interchange by each of a plurality of types of power interchange from the source microgrid with the destination microgrid, and
determining to perform respective types of power interchange of the plurality of types of power exchange in ascending order of respective costs for power interchange.

15. The supply and demand adjustment method according to claim 5, wherein,
when it is determined that supply and demand adjustment is necessary after power interchange between the plurality of microgrids, the determining further comprises determining to perform the supply and demand adjustment by power control in the plurality of microgrids.

16. The computer-readable non-transitory recording medium according to claim 6, wherein
the determining further comprises:
selecting, as the source microgrid as the power interchange source having a highest surplus resolution priority order from among one or more microgrids of the plurality of microgrids in which surplus power is generated, and
selecting, as the destination microgrid as the power interchange destination having a highest tightness resolution priority order from among one or more microgrids of the plurality of microgrids in which power shortage has occurred.

17. The computer-readable non-transitory recording medium according to claim 6, wherein
the determining further comprises:
calculating a cost for power interchange by each of a plurality of types of power interchange from the source microgrid with the destination microgrid, and
determining to perform respective types of power interchange of the plurality of types of power exchange in ascending order of respective costs for power interchange.

18. The computer-readable non-transitory recording medium according to claim 6, wherein
when it is determined that supply and demand adjustment is necessary after power interchange between the plurality of microgrids, the determining further comprises determining to perform the supply and demand adjustment by power control in the plurality of microgrids.
